(19) United States
(12) Patent Application Publication
(10) Pub. No.: US 2017/0185913 A1
(43) Pub. Date: Jun. 29, 2017

(54) SYSTEM AND METHOD FOR COMPARING TRAINING DATA WITH TEST DATA

(71) Applicant: International Business Machines Corporation, Armonk, NY (US)

(72) Inventors: Noel Christopher CODELLA, White Plains, NY (US); John Ronald KENDER, Leonia, NJ (US); John Richard SMITH, New York, NY (US)

(21) Appl. No.: 14/982,036

(22) Filed: Dec. 29, 2015

(51) Int. Cl. G06N 99/00; G06N 7/00

(52) U.S. Cl. CPC G06N 99/005; G06N 7/005

(57) ABSTRACT

An information processing system, a computer readable storage medium, and a method for comparing training data with test data. The method can include collecting by a processor of a machine learning system, training data having meta-data information used for training the machine learning system, and test data lacking meta-data information. The method can further include training the machine learning system with the training data, extracting components of the machine learning system from analysis of the training data to provide a training data extraction, extracting components of the machine learning system from analysis of the test data to provide a test data extraction, performing at least a low-dimensional comparison of the training data extraction with the test data extraction using a statistical comparison technique, and generating meta-data information for the test data when the low-dimensional comparison meets or exceeds a predetermined threshold.

### BACKGROUND

The present disclosure generally relates to machine learning systems, and more particularly relates to a system and method for comparing training data with test data.

Although machine learning techniques provide fundamental advantages over manually created systems, machine learning techniques still require a large amount of accurately annotated training data to learn how to annotate new instances accurately. Unfortunately, it is typically not feasible to provide sufficient, accurately labeled data. This is sometimes referred to as the “training data bottleneck” and it is an obstacle to practical systems, especially for so-called named entity annotation. Moreover, current machine learning systems do not provide an effective division of labor between a person, who understands the domain, and machine learning techniques, which although fast and untiring, are dependent on the accuracy and quantity of the example data in the training set. Although the level of expertise required to annotate training data is far below that required to build an annotation system by hand, the amount of effort required is still great so that such systems are either not sufficiently accurate or too costly to develop for widespread commercial deployment.

Also, all data is not equally useful to a machine learning system, as some data items are redundant or otherwise not very informative. Having a person review such data would, therefore, be costly and an inefficient use of resources. Further, since machine learning accuracy improves with greater amounts of correctly annotated training data, no matter how much data a person or persons could annotate within the time and resource constraints for a particular machine learning tasks, it would always be desirable to have a system that can leverage these annotations to automatically annotate even more training data without requiring human intervention. Given that there are cost and time limitations to the amount of data people can annotate, commercial success of automated annotation systems requires an effective technique for learning accurate automated annotations.

### BRIEF SUMMARY

According to one embodiment of the present disclosure, a method for comparison of training data with test data includes collecting by at least one processor of at least one computing device of a machine learning system, training data having meta-data information used for training the machine learning system, collecting by the at least one processor, test data lacking meta-data information, training the machine learning system with the training data, extracting components of the machine learning system from analysis of the training data to provide a training data extraction, extracting components of the machine learning system from analysis of the test data to provide a test data extraction, performing at least a low-dimensional comparison of the training data extraction with the test data extraction using a statistical comparison technique, and assigning or generating meta-data information for the test data when the at least the low-dimensional comparison meets or exceeds a predetermined threshold. In some embodiments, the method can further include presenting the comparison of the training data extraction with the test data extraction on a user interface. In some embodiments, the training data extraction and the test data extraction each have multiple components and the low-dimensional comparison generates a numerical distance between predetermined components of the machine learning system of the training data extraction and the test data extraction. In some embodiments, the method further includes the step of normalizing the multiple components of the training and test data extractions before performing the comparison. In some examples, the low-dimensional comparison is at least a pairwise dimensional comparison.

In some embodiments, the statistical comparison technique is a Jensen-Shannon Divergence technique. In some embodiments, the predetermined threshold is a number in a range between 0 and 1 indicating how similar the training data extraction is to the test data extraction. Note that the embodiments herein are not limited to text or documents (for training data or test data or both), but can include images having at least objects or concepts represented by the image and further including at least some corresponding meta-data representing the objects or concepts. In some instances, the client or test data may lack meta-data or only have a limited amount of useful meta-data. In some embodiments, the step of performing a low-dimensional comparison can be a pairwise dimensional comparison that is done as a penultimate step providing weighted components as an input to a final decision output node. In some embodiments, the pairwise dimensional comparison provides a predetermined feature relationship between predetermined components of training data extraction and the test data extraction providing a higher percentage of certainty of an accurate result relative to without using the pairwise dimensional comparison.

In some embodiments, a system for comparing training data with test data can include at least one memory and at least one processor of a machine learning system communicatively coupled to the at least one memory. One or more processors of the system can be configured to perform a method including collecting training data having meta-data information used for training the machine learning system, collecting test data lacking meta-data information, training the machine learning system with the training data, extracting components of the machine learning system from analysis of the training data to provide a training data extraction, extracting components of the machine learning system from analysis of the test data to provide a test data extraction, performing at least a low-dimensional comparison of the training data extraction with the test data extraction using a statistical comparison technique, and generating meta-data information for the test data when the at least the pairwise dimensional comparison meets or exceeds a predetermined threshold. In some embodiments, the system can further include a user interface for presenting the low-dimensional comparison.

In some embodiments, the training data includes an image having at least one of objects or concepts represented by the image and further including corresponding meta-data representing the objects or concepts. In some embodiments, the training data comprises audio having features represented by the audio and further including corresponding meta-data representing the features.

In some embodiments, the one or more processors are further configured to provide training data extraction and the test data extraction each having multiple features where the analysis produces corresponding records, such as histograms, for each of the features of the training data extraction and test data extraction. In some embodiments, the training data extraction and the test data extraction each have multiple components (or features) and each of the multiple components are normalized before performing the low-dimensional comparison. In some embodiments, the low-dimensional comparison is at least a pairwise dimensional comparison. In some embodiments the system uses a Jensen-Shannon Divergence providing a result in a range between 0 and 1 where 0 signifies zero differences and 1 signifies a maximal difference and alternatively where 0 signifies the maximal difference and 1 signifies zero differences in the comparison.

According yet to another embodiment of the present disclosure, a computer readable storage medium comprises computer instructions which, responsive to being executed by one or more processors, cause the one or more processors to perform operations as described in the methods or systems above or elsewhere herein.

### BRIEF DESCRIPTION OF THE SEVERAL VIEWS OF THE DRAWINGS

The accompanying figures, in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a depiction of flow diagram of a system or method for comparing training data with test data according to various embodiments of the present disclosure;

FIG. 2 is a block diagram illustrating an example of a system of FIG. 1;

FIG. 3 is a block diagram of an information processing system according to various embodiments of the present disclosure; and

FIG. 4 is a flow diagram illustrating a method according to various embodiments of the present disclosure.

### DETAILED DESCRIPTION

According to various embodiments of the present disclosure, disclosed is a system and method for comparing training data with client or test data. Specifically, according to an example, a method or system compares the response of the components of a machine learning system to training data versus testing data. In some embodiments, the comparison is performed via a statistical comparison technique such as the Jensen-Shannon divergence technique which can enable the easy comparison and visual display of similarity measures of components. Moreover, such techniques determine which components of a machine learning system are most responsible for machine learning inaccuracy. More particularly, some embodiments can make decisions determined based on a low-dimensional approximation of Jensen-Shannon divergence, comparing pairs of components together and based on the visual display of pair-wise similarity measures.

Existing approximation methods using the Kullback-Leibler Divergence to measure data distribution similarities have some shortcomings and suffer from technical difficulties, particularly if the number of features is large and the data are relatively small. Most importantly, current methods tend to be biased towards outlier data, which is exact opposite behavior used to detect major discrepancies between client data and product or training data.

Several embodiments herein use a different measure of similarity, the Jensen-Shannon Divergence, which can use pairs of features working together, rather than just the single outputs of features working alone, or the entire plurality of features working together. This avoids numerical difficulties of division by zero, minimizes biases towards outliers, and helps to isolate those features that are responsible for inaccuracies on client or test data.

Assuming that a client has complex data, such as images that need to be analyzed for the presence of certain content, such as sub-images of objects, backgrounds, or actions, a machine learning system as contemplated herein can use classifier programs that recognize content (such as “dog”, “cat”, etc.) by computing many features of the complex data (such as presence of certain colors or textures in certain positions of the image). The system can be trained so that each classifier expects certain amounts of certain features. However, a client's data may not have many or even any of the contents expected by the system. In some embodiments, a system compares certain statistics of the features of the training data against the same statistics of the client's data, and produces a number, from zero to one, indicating how close the collection of client data is to the collection of training data.

Specifically, for each classifier, the system examines how the features of each classifier differ between the training set in the product, and the client set (of test data) offered to it. In some embodiments, the system first normalizes the numerical response of each feature so that all features give results on a scale from zero to one, with zero meaning that the feature is definitely not present, with one meaning that the feature is definitely present, and one-half meaning that the feature cannot be determined either way. (Alternative embodiments can also switch the scale such that zero means the feature is definitely present and one means the feature is definitely not present).

In some embodiments, these normalized feature values are roughly equivalent to probability of feature presence. Technically, for each feature, the values of their responses are mapped into a logistic response curve using one of two approximations. The first approximation uses a least-squares method to fit most of the moderate values to the nearest logistic curve. The second approximation uses a heuristic method to fit most of the extreme values to the nearest logistic curve. As this curve is well-studied and has only two parameters, a and b (the equation being y=1/(1+exp(ax+b)), this method of fitting is fast and accurate.

Having normalized all feature responses to a consistent range, it now examines each classifier in a multiplicity of ways: by examining features by themselves, by examining pairs of features together, by examining triples of features, etc.

To do this, according to one example, the system first examines how each of its individual features responds to training data compared with client test data. This comparison is based on several novel ideas. First, the system quantizes the feature responses into several bins, allowing statistics to be done with integer arithmetic. The bin count and bin ranges do not need to be fixed. For each feature (or component) in the classifier, it looks at the entire training set of data and aggregates into each bin the number of times the feature has attained a value in that bin's range. Therefore, each feature produces a histogram of its response over the training set. It similarly does this with the client data. At this point, each classifier can now be seen as having two sets of histograms: one set comprising histograms, one for each feature, as determined from the training set, and another set comprising histograms, again one for each feature, but as determined from the client set. According to various embodiments, a method determines how these sets of histograms are to be compared. The method adopted, according to various embodiments, is that of the Jensen-Shannon Divergence, which is well defined for all data, does not require assumptions about histogram distributions, and gives results in a limited range (again, from zero to one) that correspond to the mathematical definition of a metric, that is, a distance. Thus, for each feature for each classifier, the method can compare how similar the training set is to the client set, in a way that makes sense to the client: zero means no differences, one means maximal difference. The method can display these differences, and also detect those particular features that create the largest differences. The method can also display identification of those particular features that create the largest differences.

The method or system, according to various embodiments, can also look at how at least a given pair of features (or components) differs between training data and (client) test data, as comparisons of individual features or components may not be as helpful. To use an analogy, it is possible to distinguish kinds of music (classical, opera, jazz, rock) on the basis of how loud individual instruments are playing, but it is more accurate to look at how pairs of instruments interact. For example, are the drums silent whenever the piano is playing? This second order statistical information can be done in a similar way, with some important technical exceptions. Although there are far more pairs of features possible, the number of bins has to be chosen more carefully and the display of feature-to-feature relationships has to be two-dimensional. For each classifier, the Jensen-Shannon distances between a pair of training features and its corresponding pair of client features is still well-defined and efficient to compute, and “bad” pairs are easy to determine. Although various embodiments are not limited to pairwise comparison, note, however, that it is usually not as helpful to extend the method to cases of triples or higher as pairs appear sufficient for image data. There could be instances where low-dimensional comparisons beyond pairwise comparisons could be helpful, but again, pairs are more than adequate for image data.

In summary, various embodiments herein apply to the problem of detecting those errors in the classification of (client) test data that are due to fundamental departures of the client's data from expectations. In many embodiments, the system or method does this by normalizing feature values out of which classifiers make decisions, then the system or method finds a robust way of comparing single features and/or pairs of features or components using a statistical comparison technique such as the Jensen-Shannon distance between properly binned feature histograms, so that the major differences can be detected and localized.

A discussion of various embodiments of the present disclosure will be provided below illustrating in more detail several examples.

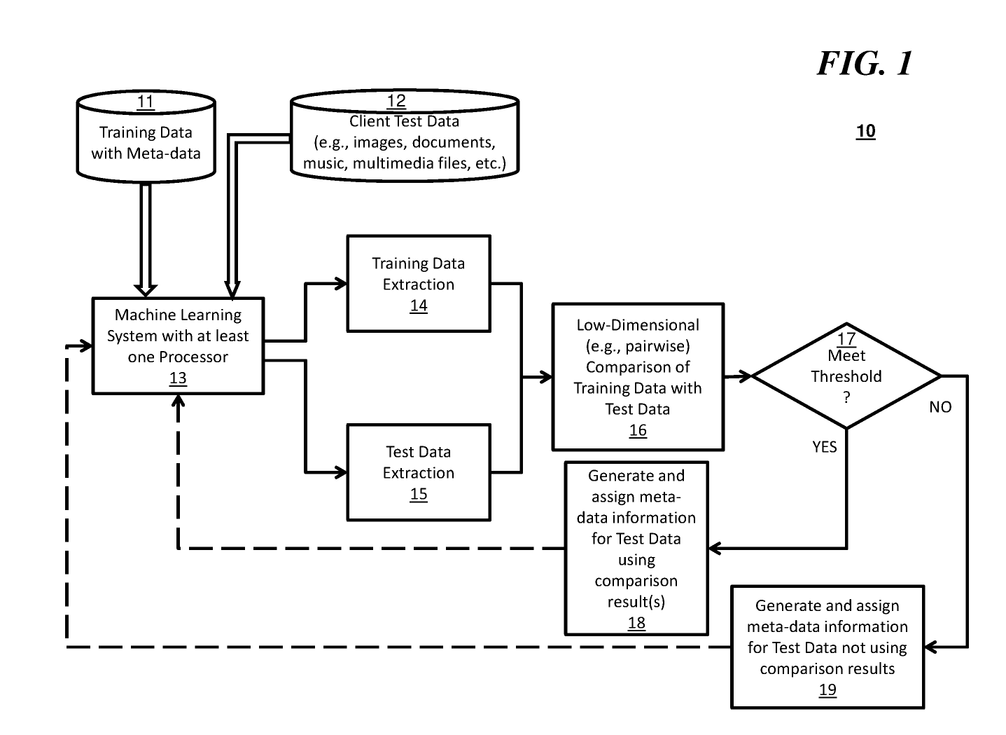

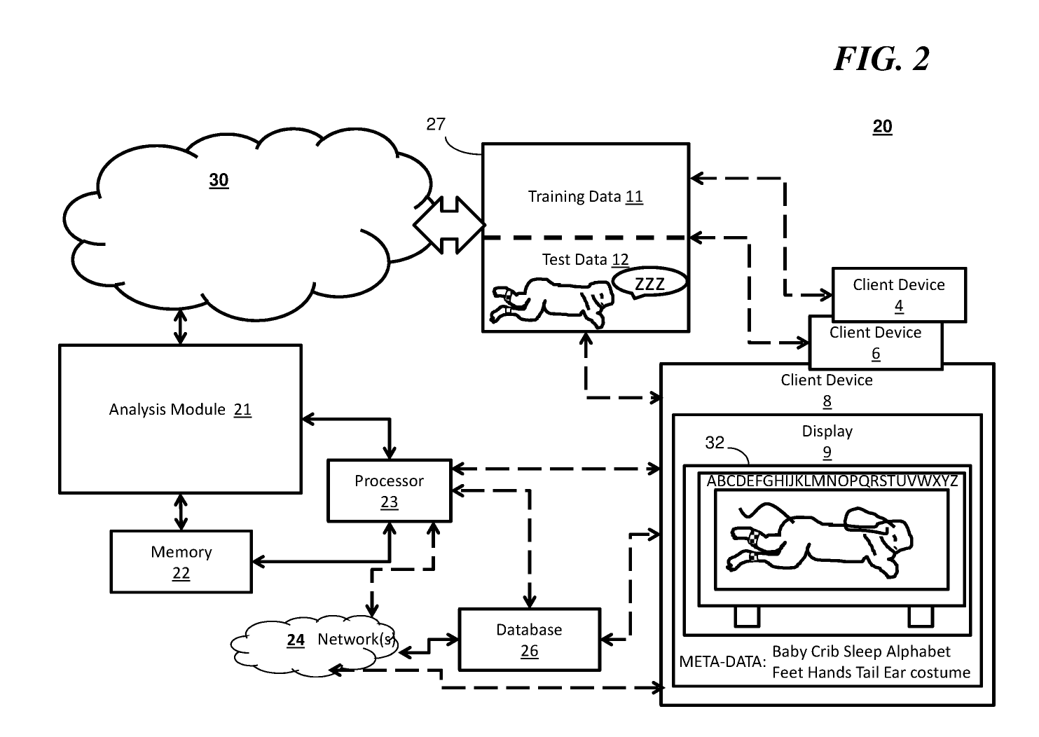

Referring to the flow diagram of FIG. 1 and according to one embodiment of the present disclosure, a method or system 10 for comparison of training data 11 with test data 12 includes collecting by at least one processor 13 of at least one computing device of a machine learning system, training data having meta-data information (11) used for training the machine learning system and collecting by the at least one processor 13, test data (12) lacking meta-data information. The system 10 can include training the machine learning system with the training data, extracting components of the machine learning system from analysis of the training data to provide a training data extraction 14, extracting components of the machine learning system from analysis of the test data to provide a test data extraction 15, performing at least a low-dimensional comparison at block 16 of the training data extraction with the test data extraction using a statistical comparison technique, and assigning or generating meta-data information for the test data at block 19 when the low-dimensional comparison meets or exceeds a predetermined threshold at decision block 17. In some embodiments, the method can further include presenting the comparison of the training data extraction with the test data extraction on a user interface (see FIG. 2). In some embodiments, the training data extraction and the test data extraction each have multiple components and the low-dimensional comparison generates a numerical distance between predetermined components of the machine learning system of the training data extraction and the test data extraction. In some embodiments, the method further includes the step of normalizing the multiple components of the training and test data extractions before performing the comparison. In some examples, the low-dimensional comparison is at least a pairwise dimensional comparison.

In some embodiments, the statistical comparison technique is a Jensen-Shannon Divergence technique. In some embodiments, the predetermined threshold is a number in a range between 0 and 1 indicating how similar the training data extraction is to the test data extraction. Note that the embodiments herein are not limited to text or documents (for training data or test data or both), but can include images having at least objects or concepts represented by the image and further including at least some corresponding meta-data representing the objects or concepts. In some instances, the client or test data may lack meta-data or only have a limited amount of useful meta-data. In some embodiments, the step of performing a low-dimensional comparison can be a pairwise dimensional comparison that is done as a penultimate step providing weighted components or features as an input to a final decision output node. In some embodiments, the pairwise dimensional comparison provides a predetermined feature (or component) relationship between predetermined components of training data extraction and the test data extraction providing a higher percentage of certainty of a result and less ambiguity.

In some embodiments, a system 20 for comparing training data with test data as shown in FIG. 2 can include at least one memory 22 and at least one processor 23 of a machine learning system (such as system 20) communicatively coupled to the at least one memory 22. One or more processors (23) of the system 20 can be configured to perform a method. The method includes, according to various embodiments, collecting training data 11 having meta-data information used for training the machine learning system 20, collecting test data 12 lacking meta-data information, training the machine learning system 20 with the training data, extracting components of the machine learning system from analysis of the training data using an analysis module 21 to provide a training data extraction, extracting components of the machine learning system from analysis of the test data to provide a test data extraction, performing at least a low-dimensional comparison of the training data extraction with the test data extraction using a statistical comparison technique, and generating meta-data information for the test data when the at least the pairwise dimensional comparison meets or exceeds a predetermined threshold.

In some embodiments, the system 20 can further include a user interface that is presented in a display 9 of a client device 8 (or other client devices 4 or 6) for presenting the low-dimensional comparison. The data, extractions, or results can be present and/or stored locally or remotely and can be sent and processed through the cloud 30 or other networks 24 and managed through databases 26 or 27. The order and arrangement of processing and storing the data shown in FIGS. 1 and 2 are mere examples and such arrangements or ordering in accordance with the various embodiments are not limited thereto.

In some embodiments as shown in the display 9 of FIG. 2, the training data includes a plurality of images such as image 32 having at least one of objects (such as a baby, or crib or an alphabet) or concepts (such as sleep) represented by the image 32 and further including corresponding meta-data representing the objects or concepts. Test data 12 can include a plurality of images such as a sleeping human baby vocalizing or getting sleep as further represented by the callout “zzz” that might otherwise look like a dog, or a rabbit or a monkey in other contexts. An extraction of the test data might result in meta-data such as “baby, alphabet (due to the “zzz”s), sleep, hand, and feet, for example. A pairwise comparison between the training data and test data might look at “baby” and “alphabet” as a pair and make a higher probability determination that the images in the test data are more likely a human baby than a dog, rabbit, or monkey. Another pairwise analysis can also look at the absence of certain elements or components such as a lack of a combination of a tail and a floppy ear (tail and floppy ears being more likely found in a dog or rabbit). In some embodiments, the training data (and/or test data) is not just limited to images, but can include audio having features represented by the audio and further including corresponding meta-data representing the features. In yet other embodiments, the training data (and/or test data) can include multimedia and corresponding meta-data.

In another non-limiting example, assume the client test data shows a collection of ambiguous images of a dog that could also be easily misinterpreted by a machine learning system as being a cat or a mouse. The test data extraction of the client's dog images extracts data such as “whiskers”, “furry”, “wet nose”, “floppy ears”, and “hanging tongue”. The training data of the machine learning system product could include this metadata and others including data representative of a cat such as “whiskers”, “furry”, “tail”, “small pointed ears”, “slit pupils” and data representative of a mouse such as “whiskers”, “tail”, “beady eyes” and “pointed ears”. A first pass comparison of features might provide a 51% confidence level that the test data is representative of a dog, a 45% confidence level that the test data is representative of a cat, and a 4% confidence level that the test data is representative of a mouse. A second pass pairwise comparison or alternatively a first pass pairwise comparison that compares pairs of features (or pairs of components) can give a greater confidence level for the results. For example, comparing confidence levels of “whiskers” and “furry” together and comparing it to other corresponding confidence levels in the training data can provide more accurate results that indicate that the client's test data is 80% likely a dog, 20% likely a cat, and 0% a mouse. Of course, if the test data is more indeterminate, the results could also reflect a lower (more accurate) confidence level after a pairwise comparison. In other words, if an initial comparison or other comparison provides a high confidence level that the test data represents for example 80% dog, 20% cat, 0% mouse, a pairwise comparison in accordance with the various embodiments could then possibly return results that only provide for a 51% dog, 49% cat, and 0% mouse image. In either case, results in accordance with the embodiments will provide a result with higher accuracy or a more accurate confidence level rating. That is, a pairwise dimensional comparison provides a predetermined feature relationship between predetermined components of training data extraction and corresponding predetermined components of test data extraction, providing a higher percentage of certainty of an accurate result relative to without using the pairwise dimensional comparison.

In some embodiments, the one or more processors 23 are further configured to provide training data extraction and the test data extraction each having multiple features (as represented by metadata) where the analysis produces corresponding histograms for each of the features of the training data extraction and test data extraction. In some embodiments, the training data extraction and the test data extraction each have multiple components (or features) and each of the multiple components are normalized (and correspondingly weighted) before performing the low-dimensional comparison. In some embodiments, the low-dimensional comparison is at least a pairwise dimensional comparison. In some embodiments as noted above, the system uses a Jensen-Shannon Divergence providing a result in a range between 0 and 1 where 0 signifies zero differences and 1 signifies a maximal difference (and alternatively in other embodiments where 0 signifies the maximal difference and 1 signifies zero differences in the comparison).

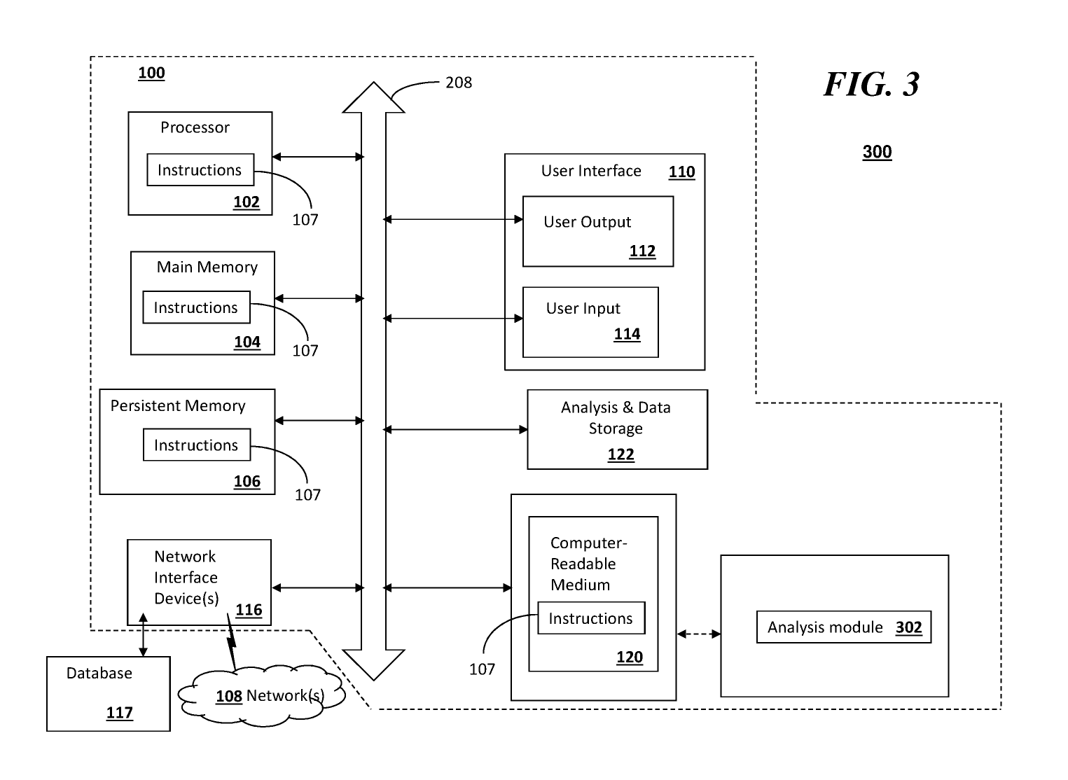

As shown in FIG. 3, an information processing system 100 of a system 300 can be communicatively coupled with the analysis module 302 and a group of client devices as shown in FIG. 2, or coupled to a presentation device for display at any location at a terminal or server location. According to this example, at least one processor 102, responsive to executing instructions 107, performs operations to communicate with the analysis module 302 via a bus architecture 208, as shown. The at least one processor 102 is communicatively coupled with main memory 104, persistent memory 106, and a computer readable medium 120. The processor 102 is communicatively coupled with an Analysis & Data Storage 122 that, according to various implementations, can maintain stored information used by, for example, the analysis module 302 and more generally used by the information processing system 100. Optionally, for example, this stored information can include information received from the client devices 4, 6, 8, of FIG. 2. For example, this stored information can be received periodically from the client devices and updated or processed over time in the Analysis & Data Storage 122. That is, according to various example implementations, a history log of the information received over time from the client devices 4, 6, 8, can be stored in the Analysis & Data Storage 122. Additionally, according to another example, a history log can be maintained or stored in the Analysis & Data Storage 122 of the information processed over time. The analysis module 302, and the information processing system 100, can use the information from the history log such as in the analysis process and in making decisions related to determining a comparison between training data and test data.

The computer readable medium 120, according to the present example, can be communicatively coupled with a reader/writer device (not shown) that is communicatively coupled via the bus architecture 208 with the at least one processor 102. The instructions 107, which can include instructions, configuration parameters, and data, may be stored in the computer readable medium 120, the main memory 104, the persistent memory 106, and in the processor's internal memory such as cache memory and registers, as shown.

The information processing system 100 includes a user interface 110 that comprises a user output interface 112 and user input interface 114. Examples of elements of the user output interface 112 can include a display, a speaker, one or more indicator lights, one or more transducers that generate audible indicators, and a haptic signal generator. Examples of elements of the user input interface 114 can include a keyboard, a keypad, a mouse, a track pad, a touch pad, a microphone that receives audio signals, a camera, a video camera, or a scanner that scans images. The received audio signals or scanned images, for example, can be converted to electronic digital representation and stored in memory, and optionally can be used with corresponding voice or image recognition software executed by the processor 102 to receive user input data and commands, or to receive test data for example.

A network interface device 116 is communicatively coupled with the at least one processor 102 and provides a communication interface for the information processing system 100 to communicate via one or more networks 108. The networks 108 can include wired and wireless networks, and can be any of local area networks, wide area networks, or a combination of such networks. For example, wide area networks including the Internet and the web can inter-communicate the information processing system 100 with other one or more information processing systems that may be locally, or remotely, located relative to the information processing system 100. It should be noted that mobile communications devices, such as mobile phones, Smart phones, tablet computers, lap top computers, and the like, which are capable of at least one of wired and/or wireless communication, are also examples of information processing systems within the scope of the present disclosure. The network interface device 116 can provide a communication interface for the information processing system 100 to access the at least one database 117 (e.g., see also databases 26, 27, shown in FIG. 2) according to various embodiments of the disclosure.

The instructions 107, according to the present example, can include instructions for monitoring, instructions for analyzing, instructions for retrieving and sending information and related configuration parameters and data. It should be noted that any portion of the instructions 107 can be stored in a centralized information processing system or can be stored in a distributed information processing system, i.e., with portions of the system distributed and communicatively coupled together over one or more communication links or networks.

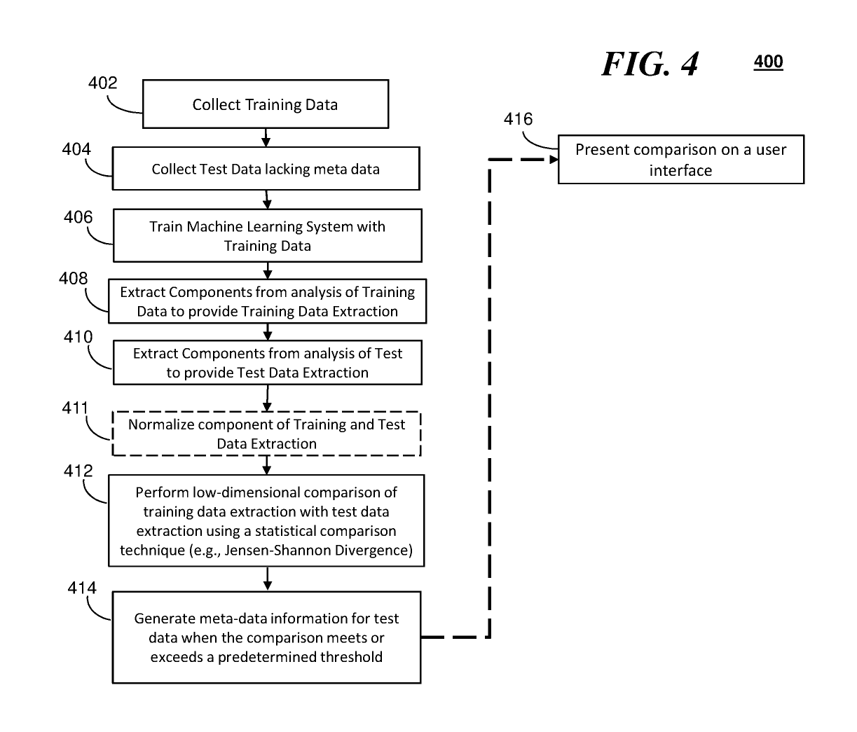

FIG. 4 illustrates an example of a method that operates, according to various embodiments of the present disclosure, in conjunction with the information processing system of FIG. 3. Specifically, according to the example shown in FIG. 4, a method 400 for comparison of training data with test data includes: collecting, at step 402, training data having meta-data information used for training the machine learning system, collecting, at step 404, test data lacking meta-data information, and training, at step 406, the machine learning system with the training data. The method 400 further includes extracting components of the machine learning system from analysis of the training data to provide a training data extraction, at step 408, and extracting components of the machine learning system from analysis of the test data to provide a test data extraction, at step 410.

In some embodiments, the method 400 further includes the step 411 of normalizing the multiple components of the training and test data extractions before performing the comparison, at step 412. The comparison, at step 412, can include at least a low-dimensional comparison of the training data extraction with the test data extraction using a statistical comparison technique such as a Jensen-Shannon Divergence technique. At step 414, the method can assign or generate meta-data information for the test data when the low-dimensional comparison meets or exceeds a predetermined threshold. The threshold can be a certain percentage confidence level or some other statistical or numerical valuation. In some embodiments, the method can further include presenting the comparison of the training data extraction with the test data extraction on a user interface, at step 416.

In some embodiments, the training data extraction and the test data extraction each have multiple components and the low-dimensional comparison generates a numerical distance between predetermined components of the machine learning system of the training data extraction and the test data extraction. In some examples, the low-dimensional comparison is at least a pairwise dimensional comparison.

### NON-LIMITING EXAMPLES

The present invention may be a system, a method, and/or a computer program product. The computer program product may include a computer readable storage medium (or media) having computer readable program instructions thereon for causing a processor to carry out aspects of the present invention.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer readable program instructions described herein can be downloaded to respective computing/processing devices from a computer readable storage medium or to an external computer or external storage device via a network or networks, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flow diagram illustrations and/or block diagrams of methods, apparatus (systems), and computer program products according to embodiments of the invention. It will be understood that each block of the flow diagram illustrations and/or block functional diagrams, and combinations of blocks in the flow diagram illustrations and/or block functional diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagrams and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow diagram and/or functional block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow diagram and/or block diagram block or blocks.

The flow diagram and block diagrams in the Figures illustrate the architecture, functionality, and operation of possible implementations of systems, methods, and computer program products according to various embodiments of the present invention. In this regard, each block in a flow diagram or block diagram may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow diagram illustration, and combinations of blocks in the block diagrams and/or flow diagram illustration, can be implemented by special purpose hardware-based systems that perform the specified functions or acts or carry out combinations of special purpose hardware and computer instructions.

While the computer readable storage medium is shown in an example embodiment to be a single medium, the term “computer readable storage medium” should be taken to include a single medium or multiple media (e.g., a centralized or distributed database, and/or associated caches and servers) that store the one or more sets of instructions. The term “computer-readable storage medium” shall also be taken to include any non-transitory medium that is capable of storing or encoding a set of instructions for execution by the machine and that cause the machine to perform any one or more of the methods of the subject disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a computer-readable storage medium, as listed herein and including art-recognized equivalents and successor media, in which the software implementations herein are stored.

Although the present specification may describe components and functions implemented in the embodiments with reference to particular standards and protocols, the disclosure is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Although only one processor is illustrated for an information processing system, information processing systems with multiple CPUs or processors can be used equally effectively. Various embodiments of the present disclosure can further incorporate interfaces that each includes separate, fully programmed microprocessors that are used to off-load processing from the processor. An operating system (not shown) included in main memory for the information processing system may be a suitable multitasking and/or multiprocessing operating system, such as, but not limited to, any of the Linux, UNIX, Windows, and Windows Server based operating systems. Various embodiments of the present disclosure are able to use any other suitable operating system. Various embodiments of the present disclosure utilize architectures, such as an object oriented framework mechanism, that allows instructions of the components of operating system (not shown) to be executed on any processor located within the information processing system. Various embodiments of the present disclosure are able to be adapted to work with any data communications connections including present day analog and/or digital techniques or via a future networking mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop personal computer (laptop PC), a tablet computer, a smart phone, a mobile phone, a wireless communication device, a personal digital assistant, a workstation, and the like. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

What is claimed is:

1. A method comprising:
collecting by at least one processor of at least one computing device of a machine learning system, training data having meta-data information used for training the machine learning system;
collecting by the at least one processor, test data lacking meta-data information;
training the machine learning system with the training data;
extracting components of the machine learning system from analysis of the training data to provide a training data extraction;
extracting components of the machine learning system from analysis of the test data to provide a test data extraction;
performing at least a low-dimensional comparison of the training data extraction with the test data extraction using a statistical comparison technique; and
generating meta-data information for the test data when the at least the low-dimensional comparison meets or exceeds a predetermined threshold.

2. The method of claim 1, further comprising presenting the low-dimensional comparison of the training data extraction with the test data extraction on a user interface.

3. The method of claim 1, wherein the training data extraction and the test data extraction each have multiple components and the low-dimensional comparison generates a numerical distance between predetermined components of the machine learning system of the training data extraction and the test data extraction.

4. The method of claim 1, wherein the training data extraction and the test data extraction each have multiple components and each of the multiple components are normalized before performing the low dimensional comparison.

5. The method of claim 1, wherein the low-dimensional comparison is at least a pairwise dimensional comparison.

6. The method of claim 1, wherein the predetermined threshold is a number in a range between 0 and 1 indicating how similar the training data extraction is to the test data extraction.

7. The method of claim 1, wherein the statistical comparison technique uses a Jensen-Shannon Divergence.

8. The method of claim 1, wherein the training data comprises an image having at least one of objects or concepts represented by the image and further including corresponding meta-data representing the objects or concepts.

9. The method of claim 1, wherein the step of performing the at least the pairwise dimensional comparison is a penultimate step providing weighted components as an input to a final decision output node.

10. The method of claim 1, wherein the pairwise dimensional comparison provides a predetermined feature relationship between predetermined components of training data extraction and the test data extraction providing a higher percentage of certainty of an accurate result, relative to without using the pairwise dimensional comparison.

11. A system comprising:
at least one memory; and
at least one processor of a machine learning system communicatively coupled to the at least one memory, the at least one processor, responsive to instructions stored in memory, being configured to perform a method comprising:
collecting training data having meta-data information used for training the machine learning system;
collecting test data lacking meta-data information;
training the machine learning system with the training data;
extracting components of the machine learning system from analysis of the training data to provide a training data extraction;
extracting components of the machine learning system from analysis of the test data to provide a test data extraction;
performing at least a low-dimensional comparison of the training data extraction with the test data extraction using a statistical comparison technique; and
generating meta-data information for the test data when the at least the pairwise dimensional comparison meets or exceeds a predetermined threshold.

12. The system of claim 11, further comprising a user interface for presenting the low-dimensional comparison of the training data extraction with the test data extraction.

13. The system of claim 11, wherein the training data comprises an image having at least one of objects or concepts represented by the image and further including corresponding meta-data representing the objects or concepts.

14. The system of claim 11, wherein the training data comprises audio having features represented by the audio and further including corresponding meta-data representing the features.

15. The system of claim 11, wherein the training data extraction and the test data extraction each have multiple features and the analysis produces corresponding histograms for each of the features of the training data extraction and test data extraction.

16. The system of claim 15, wherein the low-dimension comparison is done by a comparison of the histograms of corresponding features of the training data extraction and the test data extraction, and wherein the system further comprising a user interface for presenting by displaying at least one of:
the differences compared between features of the training data extraction and corresponding features of the test data extraction; and
identification of at least one feature that created the largest difference between the features of the training data extraction and corresponding features of the test data extraction.

17. The system of claim 11, wherein the training data extraction and the test data extraction each have multiple components and each of the multiple components are normalized before performing the low-dimensional comparison.

18. The system of claim 11, wherein the low-dimensional comparison is at least a pairwise dimensional comparison.

19. The system of claim 11, wherein the statistical comparison technique uses a Jensen-Shannon Divergence providing a result in a range between 0 and 1 where 0 signifies zero differences and 1 signifies a maximal difference and alternatively where 0 signifies the maximal difference and 1 signifies zero differences in the comparison.

20. A non-transitory computer-readable medium having stored therein instructions which, when executed by at least one processor, cause a machine learning system to perform a method comprising:
collecting by the at least one processor of the machine learning system, training data having meta-data information used for training the machine learning system;
collecting by the at least one processor, test data lacking meta-data information;
training the machine learning system with the training data;
extracting components of the machine learning system from analysis of the training data to provide a training data extraction;
extracting components of the machine learning system from analysis of the test data to provide a test data extraction;
performing at least a pairwise dimensional comparison of the training data extraction with the test data extraction using a statistical comparison technique; and
generating meta-data information for the test data when the at least the pairwise dimensional comparison meets or exceeds a predetermined threshold.
